(19) United States
(12) Patent Application Publication
(10) Pub. No.: US 2022/0305857 A1
(43) Pub. Date: Sep. 29, 2022

(54) SUSPENSION SYSTEM FOR A VEHICLE AND METHOD OF ADJUSTING REAR CONTROL ARM GEOMETRY FOR SAME

(71) Applicant: MF IP Holding, LLC, West Jordan, UT (US)

(72) Inventors: Michael Grant Owens, Herriman, UT (US); Casey Heit, West Jordan, UT (US)

(73) Assignee: MF IP Holding, LLC, West Jordan, UT (US)

(21) Appl. No.: 17/211,365

(22) Filed: Mar. 24, 2021

(51) Int. Cl. B60G 3/20; B60G 7/00; B60G 7/02

(52) U.S. Cl. CPC B60G 3/20; B60G 7/001; B60G 7/02; B60G 2200/144

(57) ABSTRACT

A vehicle suspension includes and axle. An upper control arm bracket is fixedly positioned relative to the axle and defines a first axis. An upper control arm is rotatably coupled to the upper control arm bracket about the first axis. A lower control arm bracket is fixedly positioned relative to the axle and defines a second axis. A lower control arm is rotatably coupled to the lower control arm bracket about the second axis. An upper control arm relocation bracket is configured to be mounted to the axle and includes a clevis defining a third axis and configured to rotatably couple the upper control arm about the third axis. The relocation bracket includes a first aperture coaxial with the first axis when the relocation bracket is mounted to the axle and a second aperture coaxial with the second axis when the relocation bracket is mounted to the axle.

### BACKGROUND

In order to customize vehicle performance to a particular use, vehicle owners often replace original equipment manufacturer (OEM) components with aftermarket parts specifically designed to modify performance characteristics. One popular modification for off-road vehicles is to install “lift kits” and other specialized suspension components to improve traction, ground clearance, articulation, and other characteristics that improve off-road performance.

As their name implies, lift kits raise the ride height (ground clearance) of a vehicle by allowing the use of larger diameter tires. Lift kits can also increase the amount of available axle travel. However, vehicle suspensions are complex systems engineered to balance many performance characteristics that are often at odds with each other. Changing the suspension geometry and components may improve certain performance characteristics but may do so at the expense of others. For example, in addition to providing improved clearance by increasing ride height, lift kits also raise the center of mass of a vehicle, which can make a vehicle more prone to rollover and can negatively impact overall vehicle performance, particularly for vehicles that will be used both off-road and on roads and highways.

FIG. 1 shows a partial view of a known vehicle 30 with a rear suspension 50 that has been modified for off-road performance. More specifically, a lift kit has been installed to raise the ride height of the vehicle approximately 2.5 inches at the rear axle.

The vehicle includes a frame 40 supported by a suspension 50 that includes the wheels, axles, springs, shock absorbers, linkages, steering components, and other associated parts. Generally speaking, the suspension 50 is made up of the vehicle components positioned between the frame 40 of the road to support the vehicle 30

The illustrated frame 40 is a ladder-type frame with a pair of parallel frame rails 42 extending along the length of the vehicle. A plurality of transverse crossmembers 44 extend between the frame rails 40 to provide suitable strength and stiffness to avoid failure and undue deflection when the vehicle is subject to both static and dynamic loads. The frame 40 also provides mounting features for various vehicle components.

Still referring to FIG. 1, the suspension 50 includes an axle assembly 52 with a wheel hub 54 and brake assembly 56 at each end. The axle assembly 52 includes a pair of axle shafts (not shown) that are connected a locking differential 58. The differential 50 includes a pinion 60 that interfaces with a drive shaft via a universal joint. The drive shaft rotates the pinion 60 about a pinion centerline 300, and the differential 50 converts rotation about the pinion centerline 300 into rotation of the axle shafts about an axle axis 302.

The axle assembly 52 is coupled to each frame rail 42 of the frame 40 by a pair of elongate controls arms. As best shown in FIGS. 2-5, an upper control arm 70 has a forward end 72 rotatably coupled about an axis 304 to a bracket 46 that is fixedly coupled to the frame rail 42. A rear end 74 of the upper control arm 70 is rotatably coupled about an axis 306 to a bracket 62 that is fixedly coupled to the axle assembly 52. Similar to the upper control arm 70, a lower control arm 80 has a forward end 82 rotatably coupled about an axis 308 to a bracket 48 that is fixedly coupled to the frame rail 42 forward of and below bracket 46. A rear end 84 of the lower control arm 80 is rotatably coupled about an axis 310 to a bracket 64 that is fixedly coupled to the axle assembly 52 below and outboard of bracket 62.

At each frame rail 42, the control arms 70, 80 cooperate with the axle assembly 52 and the frame rail to form a 4-bar linkage. In addition to controlling the longitudinal position of the axle assembly 52 relative to the frame 40, this 4-bar linkage also controls the rotational orientation of the axle assembly about axis 302 to prevent the axle assembly from “rolling over” in response to braking and acceleration forces.

Referring back to FIG. 1, the suspension 50 includes an elongate track bar 90 extending in a generally lateral direction across the vehicle. One end of the track bar 90 is rotatably coupled to the frame, and the other end of the track bar is rotatably coupled to the axle assembly 52. The track bar 90 controls the lateral position of the axle assembly 52 relative to the frame 40 while still allowing the axle assembly to move vertically relative to the frame.

A sway bar assembly 92 includes a sway bar 94 extending laterally across the frame and rotatably mounted thereto. Each end of the sway bar 94 is coupled to an end of the axle assembly 52 such that movement of the end of the axle assembly in an up or down direction rotates the corresponding end of the sway bar in a first or second direction, respectively. As the vehicle 30 rolls to one side or the other, the sway bar 94 acts as a torsion spring that resists the roll.

On each side, a coil spring (not shown) is mounted vertically between an upper bracket 96, which is mounted to the frame rail 42, and a lower bracket 98, which is mounted to the axle assembly 52. The springs transfer vertical loads from the frame 40 to the axle assembly 52 and determine, at least in part, the ride height of the vehicle 30. Spring compression is limited by a bump stop 66 mounted to the frame 40 at each side. As the spring compresses, the bump stop 66 moves toward a bump pad 68 mounted to the axle assembly 52. When the bump stop 66 contacts the bump pad 68, further travel of the axle assembly 52 toward the frame 40 is prevented. By limiting travel of the axle assembly 52 toward the frame 40, the bump stop 66 prevents one or more of (1) over-compression of the springs, (2) the tires from rubbing on the body, and/or (3) bottoming out of the vehicle 30.

Aftermarket lift kits for an off-road vehicle may include various combinations of replacement springs, control arms, sway bar link, bump stops, shock absorbers, track bars, and other suspension components and related hardware. By design, these components change the geometry of the vehicle suspension. However, OEM vehicle suspensions are complex, highly engineered systems, and making changes to the suspension geometry can have unexpected and undesirable effects on the vehicle performance.

FIGS. 2-4 show a side view of the vehicle suspension 50 of FIG. 1 in at nominal (ride) height, full bump, and full droop, respectively. The illustrated ride height is the vehicle configuration on the ground with no cargo or passengers. At full bump, the bump stop 66 is in contact with the bump pad 68 and the springs are at maximum compression. At full droop, the axle assembly 52 has reached the maximum distance from the nominal height. Full droop is typically controlled by full shock absorber extension; however, other components may limit axle assembly 52 travel relative to the frame 52.

While the installed lift kit provides increase in ride height, it does so at the expense of performance in some areas. As will be discussed in further detail, installation of the lift kit dramatically changes the instant center of the rear suspension, resulting in increased anti-squat characteristics of the vehicle. In addition, as a result of the modified control arm geometry, rotation of the axle assembly 52 as the suspension 50 moves toward full droop increases the pinion angle and would potentially cause binding.

### SUMMARY

A claimed embodiment of an upper control arm relocation bracket is configured for use with a vehicle suspension. The suspension includes an axle and an upper control arm bracket fixedly positioned relative to the axle. The upper control arm bracket defines a first axis and is configured to rotatably couple an upper control arm about the first axis. The suspension further includes a lower control arm bracket fixedly positioned relative to the axle. The lower control arm bracket defines a second axis and is configured to rotatably couple a lower control arm about the second axis. The upper control arm relocation bracket is configured to be mounted to the axle and includes a clevis. The clevis defines a third axis and is configured to rotatably coupled the upper control arm about the third axis. The upper control arm relocation further includes first and second apertures. When the upper control arm relocation bracket is mounted to the axle, the first aperture is coaxial with the first axis, and the second aperture coaxial with the second axis.

In any embodiment, the third axis is parallel to the first axis.

In any embodiment, a fastener that couples the lower control arm to the lower control arm bracket extends through the second aperture to couple the upper control arm relocation bracket to the lower control arm bracket.

In any embodiment, the upper control arm relocation bracket further comprises a lug, wherein the second aperture extends through the lug.

In any embodiment, a first face of the lug engages the lower control arm bracket when the upper control arm relocation bracket is mounted to the axle.

In any embodiment, a counterbore extends partially through the lug from a second face.

In any embodiment, a second fastener extends along the first axis to couple the bracket to the upper control arm bracket.

In any embodiment, the upper control arm bracket comprises an inner lug and an outer lug, the clevis engaging at least one of the inner lug and the outer lug.

In any embodiment, the inner lug is at least disposed between first and second legs of the clevis.

In any embodiment, the third axis is positioned above and forward of the second axis when the bracket is mounted to the axle.

In any embodiment, the third axis is positioned to lower an instant center of the upper and lower control arms.

In any embodiment, lowering the instant center reduces vehicle anti-squat from greater than 100% to less than 100%.

In any embodiment, the third axis is positioned to reduce pinion angle when the vehicle is in a full droop state.

A claimed embodiment of a method for modifying a control arm geometry for a vehicle suspension is suitable for use with vehicle suspension comprising an upper control coupled to an axle by an upper control arm bracket and a lower control arm coupled to the axle by a lower control arm bracket. The method comprises the steps of removing a first fastener to decouple the upper control arm from the upper control arm bracket and removing a second fastener to decouple the lower control arm from the lower control arm bracket. The method further includes the steps of coupling an upper control arm relocation bracket to the upper control arm bracket using a third fastener and coupling the upper control arm relocation bracket and the lower control arm to the lower controller arm using a fourth fastener. The method also includes the step of coupling the upper control arm to the upper control arm relocation bracket using a fifth fastener.

In any embodiment, the step of coupling the upper control arm relocation bracket to the upper control arm bracket using a third fastener includes inserting the third fastener into at least one hole of the upper control arm bracket from which the first fastener was removed.

In any embodiment, the step of coupling the upper control arm relocation bracket to the lower control arm bracket using a fourth fastener includes inserting the fourth fastener into at least one hole of the lower control arm bracket from which the second fastener was removed.

In any embodiment, the fifth fastener is the same as the second fastener.

In any embodiment, the method further includes the step of positioning the upper control arm relocation bracket next to the lower control arm bracket prior to coupling lower control arm.

In any embodiment, the upper control arm relocation bracket raises a rear end of the upper control arm.

In any embodiment, the upper control arm relocation bracket moves a rear end of the upper control arm in a forward direction.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a partial isometric view of a known rear suspension for a vehicle having an aftermarket lift kit installed;

FIG. 2 shows a partial passenger-side view thereof, wherein the suspension is in a ride height state, and the passenger side wheel hub and brake assembly are removed;

FIG. 3 shows a partial passenger-side view thereof, wherein the suspension is in a full bump state;

FIG. 4 shows a partial passenger-side view thereof, wherein the suspension is in a full droop state;

FIG. 5 shows a partial rear, passenger-side isometric view of an axle assembly of the rear suspension of FIG. 1;

FIG. 6 shows an inboard isometric view of a passenger-side upper control rod mounting bracket assembly according to a representative embodiment of the present disclosure;

FIG. 7 shows an outboard isometric view thereof;

FIG. 8 shows a partial rear, passenger-side isometric view of the axle assembly of FIG. 5 with the mounting bracket assembly of FIG. 6 mounted thereto;

FIG. 9 shows a partial passenger-side view thereof, wherein the suspension is in a ride height state, and the passenger side wheel hub and brake assembly are removed;

FIG. 10 shows a partial passenger-side view thereof, wherein the suspension is in a full bump state;

FIG. 11 shows a partial passenger-side view thereof, wherein the suspension is in a full droop state;

FIG. 12 shows the anti-squat characteristics of the suspension shown in FIG. 2, except that the suspension is in a stock configuration with no lift kit installed;

FIG. 13 shows the anti-squat characteristics of the suspension shown in FIG. 2;

FIG. 14 shows the anti-squat characteristics of the suspension shown in FIG. 9;

FIG. 15 shows the pinion angle of the suspension shown in FIG. 4; and

FIG. 16 shows the pinion angle of the suspension shown in FIG. 11.

### DETAILED DESCRIPTION

Disclosed aftermarket brackets are configured to be used in conjunction with a lift kit. When installed, the brackets relocate the rear attachment location of the rear upper control arm to adjust the control arm geometry. The modified suspension provides improved anti-squat characteristics and also prevents driveline binding at the rear differential. Embodiments of the brackets can be installed in conjunction with existing brackets without the need for cutting, welding, drilling, or otherwise modifying existing structure.

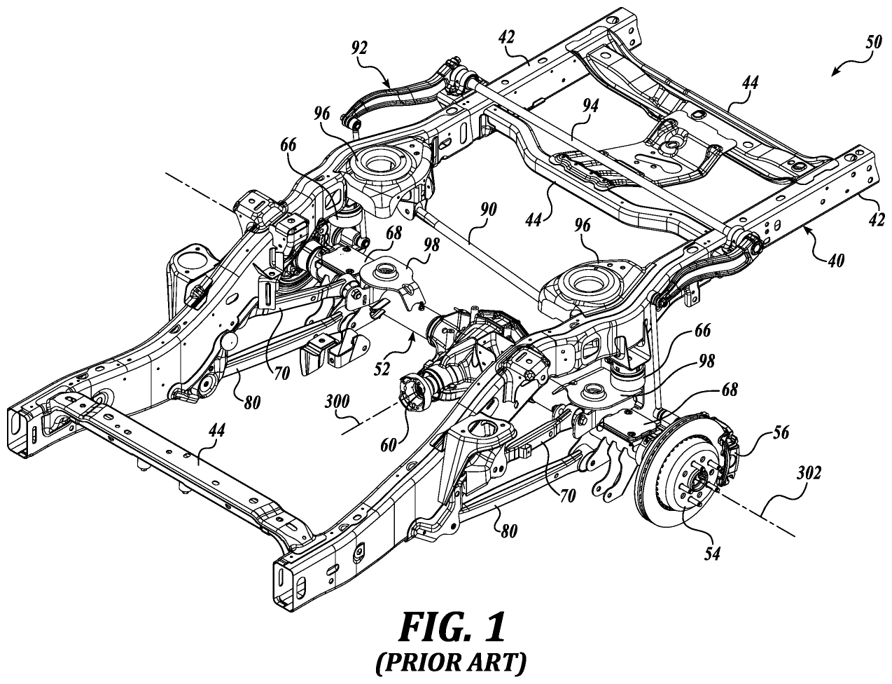

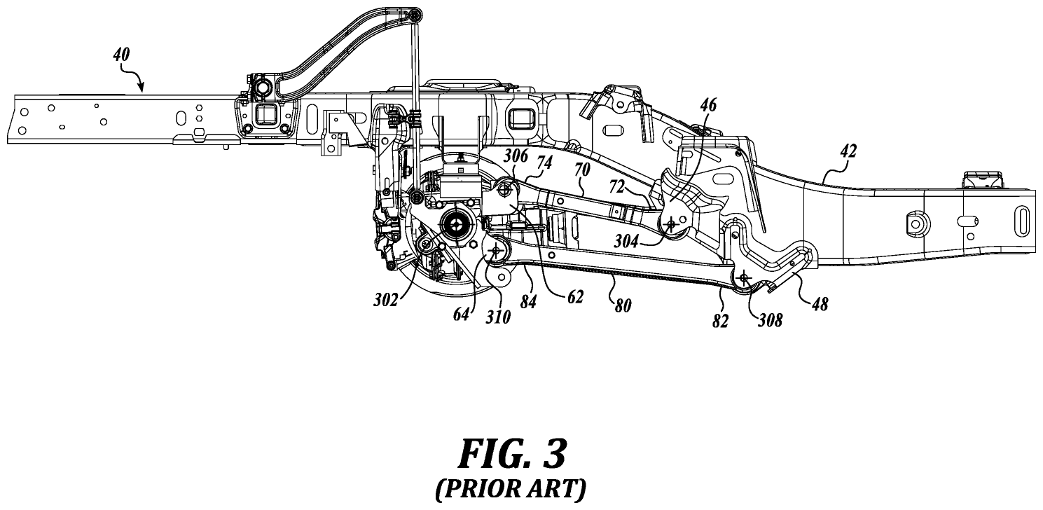

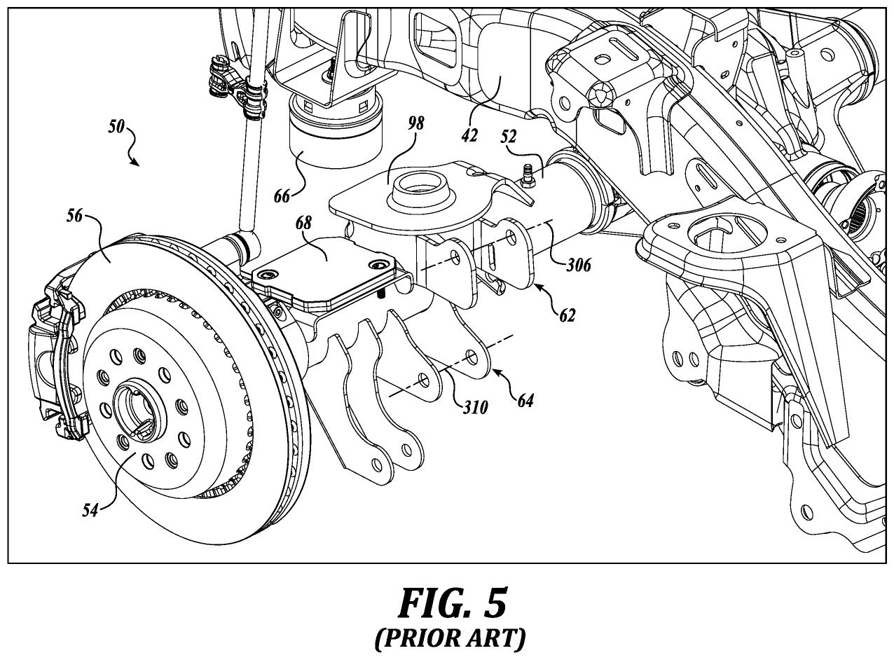

FIG. 5 shows a rear isometric view of the OEM mounting brackets for the lifted suspension 50 shown in FIGS. 1-4. The bracket 62 for mounting the rear end 74 of the upper control arm 70 includes a pair of parallel lugs mounted to the axle assembly 52 below the lower coil spring bracket 98 so that the lugs form a clevis. A hole is formed in each lug, and the holes are coaxial about axis 306. To mount the upper control arm 70 to the bracket 62, a lug at the rear end 74 of the upper control arm is positioned between the lugs of the bracket. The control arm 70 is secured to the bracket 62 by bolt/nut combination that extends through the holes in the lugs of the bracket and a hole in the control arm.

Similar to bracket 62, the bracket 64 for mounting the rear end 84 of the lower control arm 80 includes a pair of parallel lugs mounted to the axle assembly 52 to form a clevis. The bracket 64 is positioned outboard and below bracket 62, and the apertures of bracket 62, when viewed from the side, are approximately 5 inches higher than and 1 inch forward of the apertures in bracket 64. A hole is formed in each lug, and the holes are coaxial about axis 310. To mount the upper control arm 70 to the bracket 62, a lug at the rear end 74 of the upper control arm is positioned between the lugs of the bracket. The control arm 70 is secured to the bracket 62 by bolt/nut combination that extends through the holes in the lugs of the bracket and a hole in the control arm. therethrough to mount the upper control arm end to the lug bracket. When the upper control arm 70 and the lower control arm 80 are installed, the rear attachment of the upper control arm is approximately 5 inches higher than and 1 inch forward of the rear attachment of the lower control arm.

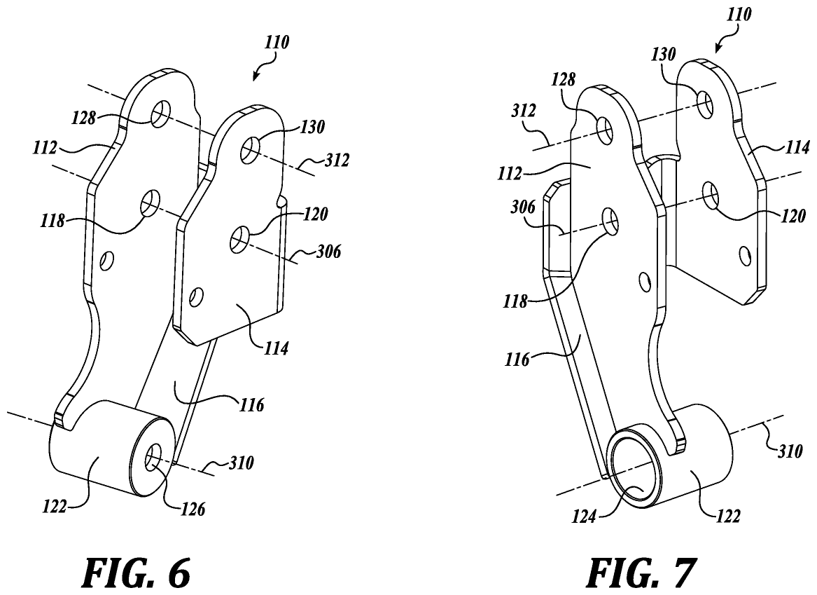

Referring now to FIGS. 6 and 7, a representative embodiment of a retrofit bracket 110 according to the present disclosure is shown. The bracket 110 includes a first leg 112 parallel to a second leg 114. The first and second legs 112 and 114 are joined by a web 116 that is perpendicular to the legs.

Coaxial holes 118 and 120 extend through the first and second legs 112 and 114, respectively. A lug 122 is disposed at one end of the fitting. The lug 122 includes an aperture 126 passing therethrough and a counterbore 124 on one side. The coaxial holes and the aperture 126 are positioned and oriented such that when the bracket is installed, axis 306 of the upper control arm bracket 62 is coincident with the axis of coaxial holes 118 and 120, and axis 310 of the lower control arm bracket 64 is coincident with the axis of the aperture126. Coaxial holes 128 and 130 are formed in the first and second legs 112 and 114, respectively, to define axis 312.

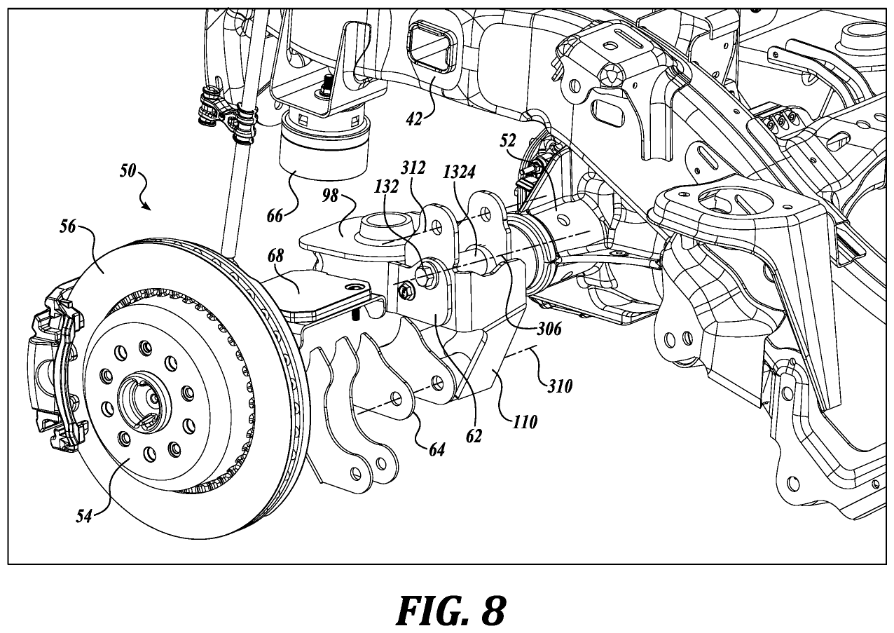

FIG. 8 shows a rear isometric view of the retrofit bracket 110 shown in FIGS. 6 and 7 mounted to the OEM mounting brackets for the lifted suspension 50 shown in FIGS. 1-4. The bracket 110 is positioned so that the first and second legs 112 and 114 of the bracket are each abutting the inboard face of one of the lugs of the upper control arm bracket 62. A bolt 132 extend through the upper control arm bracket 62 and the holes 118 and 120 of the retrofit bracket 110 along axis 306. The bolt 132 extends through a cylindrical bushing 134 that acts as a spacer between the first and second legs 1124 and 114 of the bracket 110, and a nut (not shown) secures the bolt in place.

Still referring to FIG. 8, with the fitting 110 secured to the upper control arm bracket 62, the lug 126 of the fitting is secured to the lower control arm bracket 64. More specifically, the hole 126 in the lug 122 is aligned with axis 310, and the bolt (not shown) that secures lower control arm 80 to the lower control arm bracket 64 extends through the hole 126 in the fitting 110 to secure the lug 122 of the fitting 110 to the lower control arm bracket 64.

The coaxial holes 128 and 130 in the bracket 110 provide a relocated mounting interface for the rear end 74 of the upper control arm 70. More specifically, the bracket 110 is sized and configured to have the rear end 74 of the upper control arm 70 rotatably mounted thereto about axis 312, wherein axis 312 is parallel to and offset from axis 306 of the upper control arm bracket 64. As a result, the upper control arm 70 and the lower control arm 80 are installed in conjunction with the bracket 110, the rear attachment of the upper control arm is approximately 8 inches higher than and 1.2 inch forward of the rear attachment of the lower control arm.

The disclosed retrofit bracket 110 provides a new mounting feature to which the rear end 74 of the upper control arm 70 may be rotatably coupled. Moreover, the bracket 110 is mounted to the axle assembly 52 using existing features so that no permanent modification of the OEM suspension is required to mount the rear end 74 of the upper control arm 70 in its new location. It will be appreciated that the illustrated embodiment is exemplary only, and other alternate methods of mounting a retrofit bracket are possible and should be considered within the scope of the present disclosure. In some embodiments, the position and/or configuration of retrofit bracket interface with one or more the existing components varies. In some embodiments, the bracket is coupled to existing structure using alternate fasteners or combinations of fasteners. In some embodiments, the bracket has any suitable configuration and is made from any suitable material by any suitable manufacturing process.

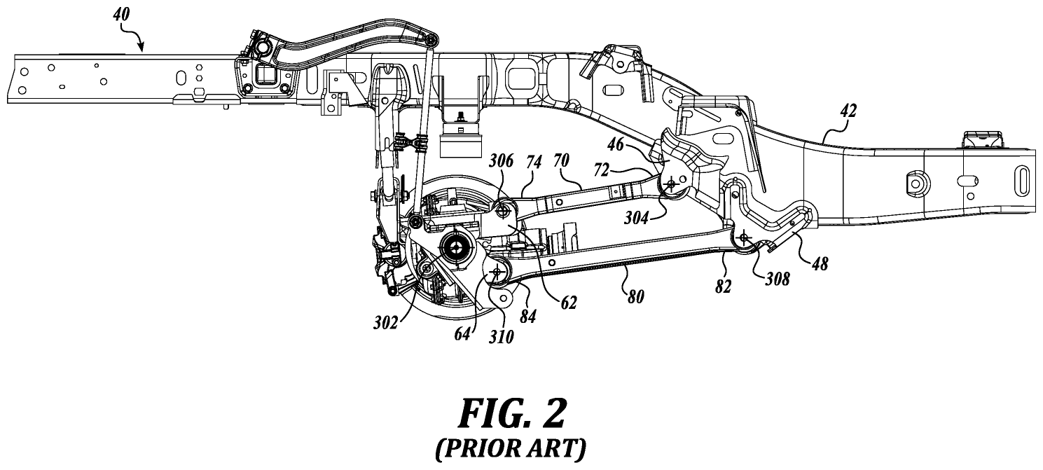

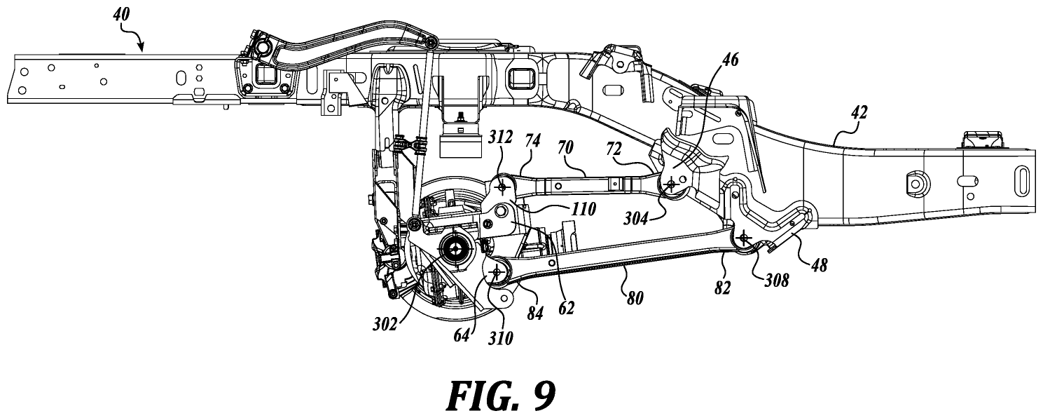

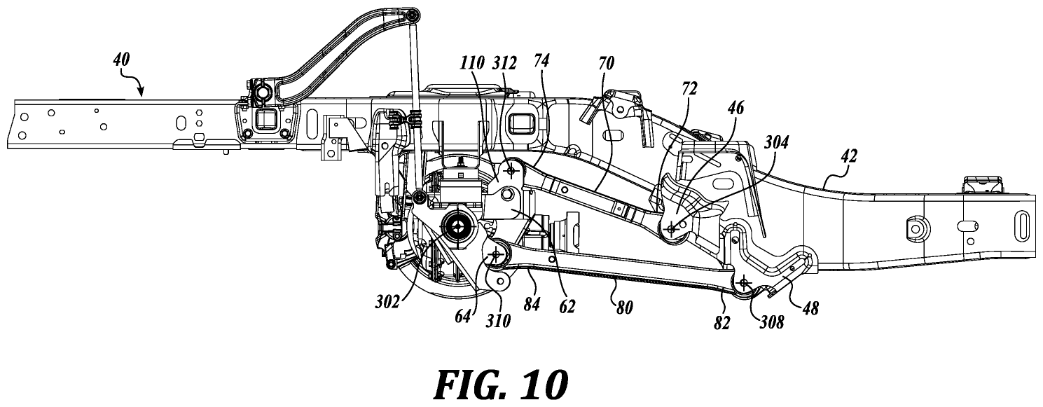

FIGS. 9-11 show a side view of the vehicle suspension 50 of FIG. 1 in at nominal (ride) height, full bump, and full droop, respectively. FIGS. 9-11 correspond to FIGS. 2-4, respectively, except that the control arm geometry has been modified by installing the retrofit brackets 110 of FIGS. 6 and 7 to change the mounting interface for the rear end 74 of the upper control arm 70. As will be discussed in further detail, the modified control arm geometry provided by the retrofit brackets 110 provide improves anti-squat performance and eliminates drive train binding cause by excessive pinion angle.

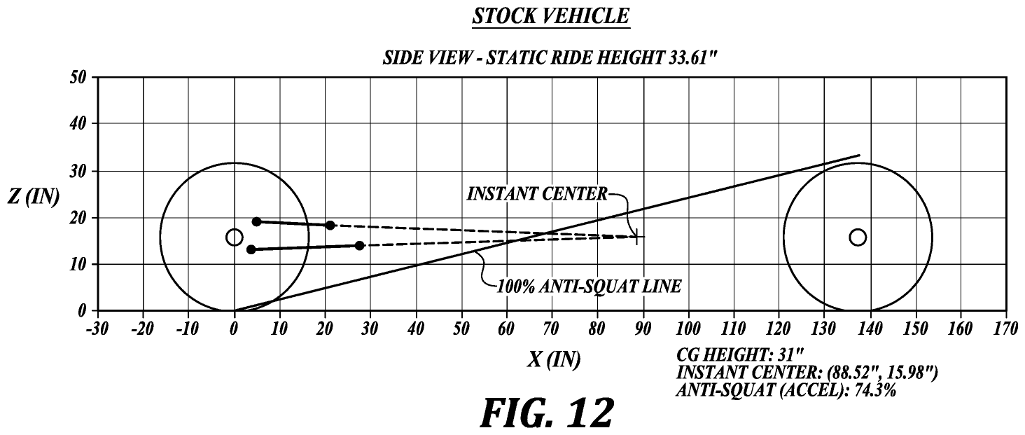

Referring now to FIGS. 12-14, the impact of the retrofit brackets 110 on the anti-squat performance of the vehicle 30 with a lift kit will be illustrated. More specifically, anti-squat of (1) the stock vehicle, (2) the vehicle 30 with the lift kit, and (3) the vehicle with the lift kit and retrofit brackets 110 will be compared.

A vehicle's anti-squat, which is expressed as a percentage, determines how the rear axle will move under acceleration. At 100% anti-squat, the suspension system is considered neutral, and acceleration will not cause the axle to move up or down. For vehicles with anti-squat values greater 100%, acceleration will raise the rear end of the vehicle, while also pushing the rear tires down to increase traction. For vehicles having anti-squat values less than 100%, acceleration will drive the rear end of the vehicle down.

Anti-squat value is derived from the instant center of the rear control arms, the wheelbase, and the center of gravity height at the front axle. The instant center of the rear control arms is the point (as viewed from the side) at which a theoretical line through the attachment points of the upper control arm would intersect with a theoretical line through the attachment points of the lower control arm. The anti-squat value represents the vertical distance of the instant center relative to a line (the 100% anti-squat line) passing through (1) the rear tire contact point and (2) the vehicle center of gravity height at the centerline of the front axle.

Referring to FIG. 12, the anti-squat characteristics of the stock vehicle 30 are shown. The vehicle 30 has a wheelbase of approximately 137 inches, a tire diameter of approximately 32.5 inches, and a center of gravity height of approximately 31 inches. The resulting anti-squat value for the stock vehicle is approximately 74% at ride height.

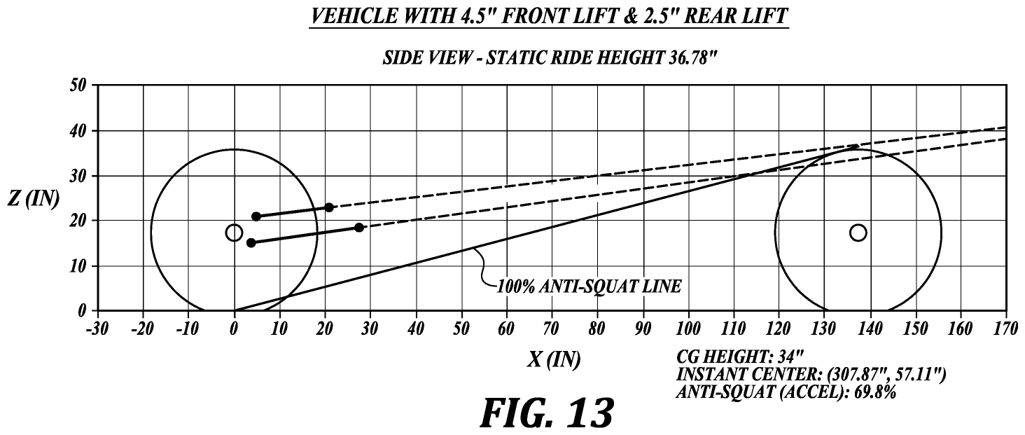

FIG. 13 shows the vehicle 30 with a lift kit, as shown in FIGS. 1-4. The lifted vehicle includes larger tires having a diameter of 36.5 inches, and the center of gravity height has increased to 34 inches. In addition, the change to the control arm geometry has moved the instant center forward approximately 120 inches and up approximately 41 inches. The resulting anti-squat value for the vehicle with the lift kit is approximately 70% at ride height.

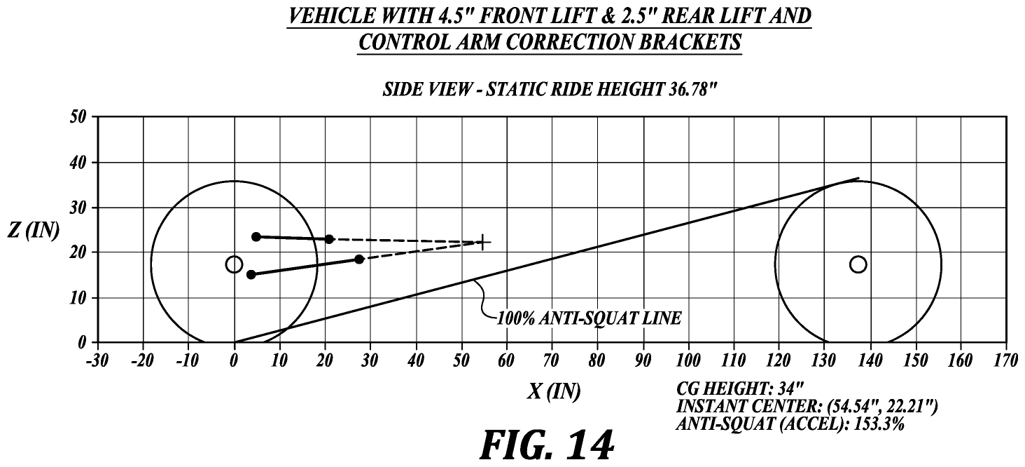

FIG. 14 shows the vehicle 30 with the lift kit and the retrofit brackets 110 to raise and move forward the rear end 74 of the upper control arm 70. The anti-squat geometry of the vehicle is basically the same as shown in FIG. 13, except that the new orientation of the upper control 70 has moved the instant center rearward approximately 154 inches and down approximately 35 inches as compared to the configuration shown in FIG. 13. As a result, anti-squat value for the vehicle with the lift kit and retrofit brackets is increased to approximately 153% at ride height.

During low-speed, off-road operation, such as rock crawling, increased anti-squat provides improved performance. For example, increased anti-squat is beneficial when climbing a steep obstacle because under power, the rear end will raise. The raised rear end provides more traction to the rear tires and also helps keep the vehicle from tipping over backwards. Increased anti-squat is also helpful when the vehicle is carrying heavy loads in the bed because the raised rear end of the vehicle makes bottoming out the suspension less likely when driving on rough terrain.

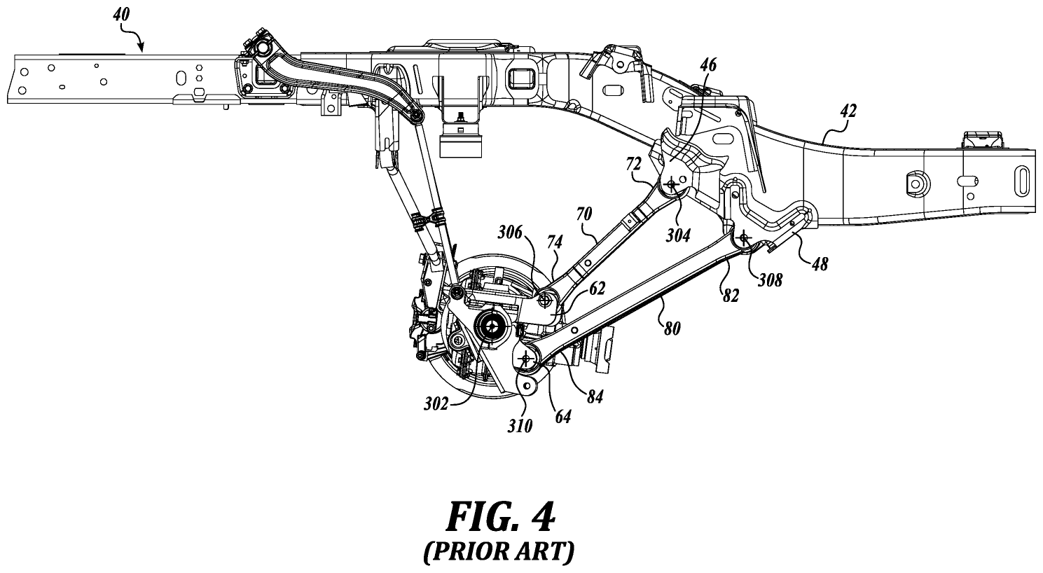

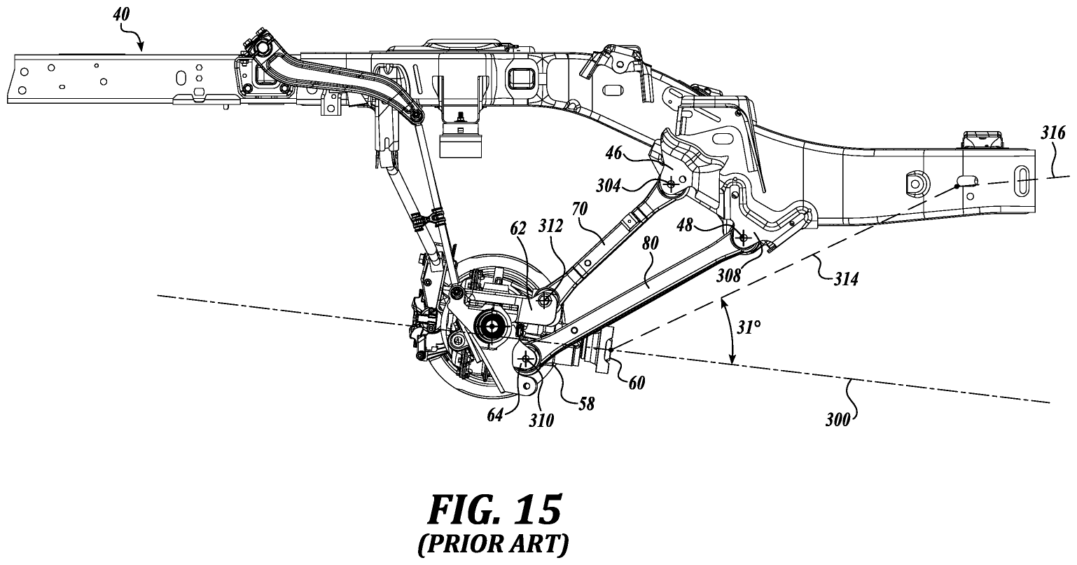

Suspension geometry changes can also result in undesirable axle wrap, wherein the axle rotates during suspension travel, causing unwanted increases in the pinion angle. FIG. 15 shows the suspension 50 with a lift kit and at full droop (similar to FIG. 4), with the pinion centerline 300, the driveshaft centerline 314, and the transmission output centerline 316 included. As the axle assembly 52 moves downward from ride height to full droop, the upper control arm 70 and lower control arm 80 rotate the axle assembly so that the pinion angle, i.e., the angle between the pinion centerline 300 and the driveshaft centerline 314, increases. In the illustrated embodiment, the pinion angle increases to approximately 31°; however, pinion angles greater than [?] can cause binding and excessive drivetrain wear that could lead to premature failure.

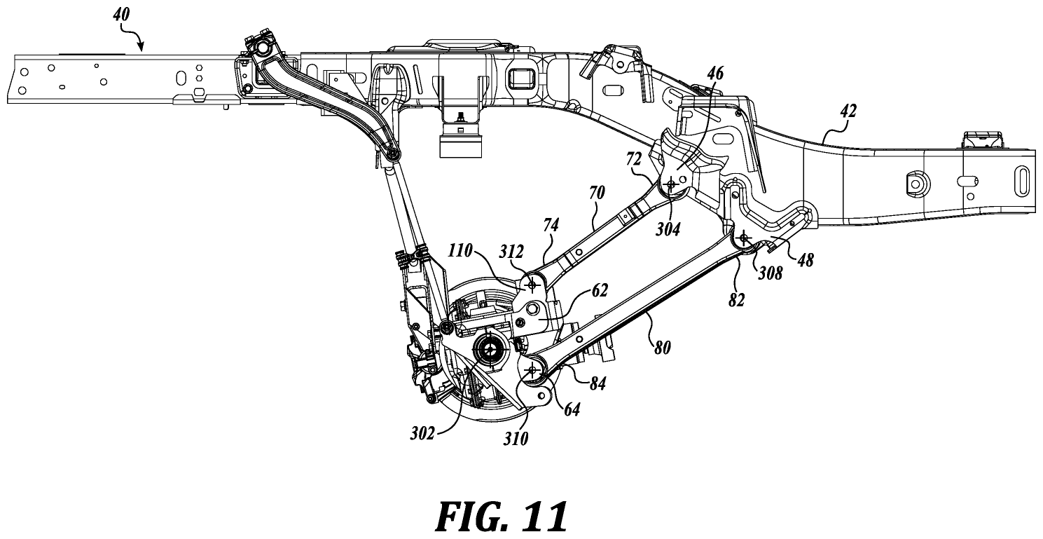

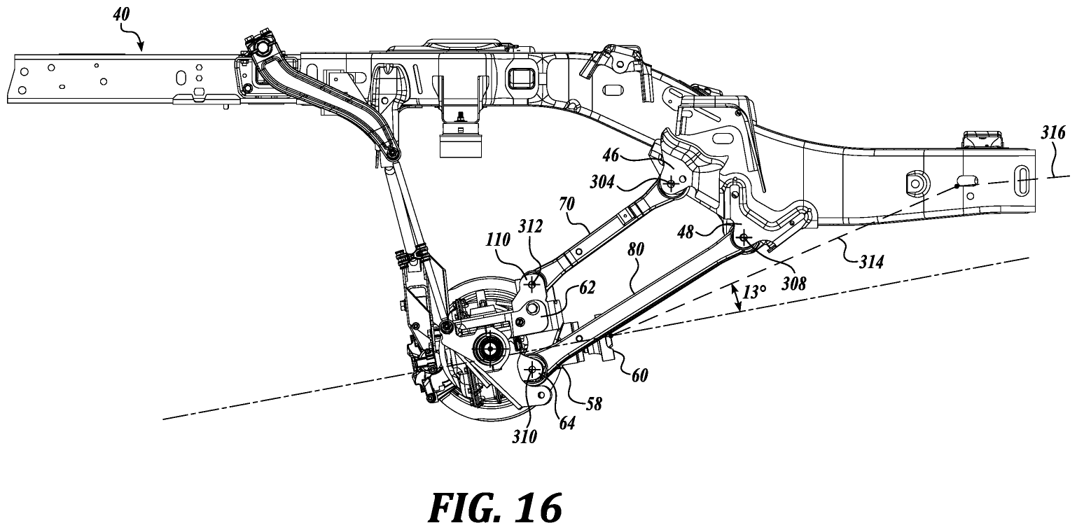

FIG. 16 shows the suspension 59 with a lift kit and retrofit brackets 110 (similar to FIG. 11) with the pinion centerline 300, the driveshaft centerline 314, and the transmission output centerline 316 included. As compared to the suspension of FIG. 15, the suspension with the retrofit brackets 110 limits rotation of the axle assembly 52 so that the pinion angle at full droop is limited to 13°. With the lower pinion angle a full droop, the drive train is less susceptible to binding and excessive wear.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. An upper control arm relocation bracket for a vehicle suspension, the vehicle suspension comprising:
an axle;
an upper control arm bracket fixedly positioned relative to the axle, the upper control arm bracket defining a first axis and being configured to rotatably couple an upper control arm about the first axis; and
a lower control arm bracket fixedly positioned relative to the axle, the lower control arm bracket defining a second axis and being configured to rotatably couple a lower control arm about the second axis,
wherein the upper control arm relocation bracket is configured to be mounted to the axle, the upper control arm relocation bracket comprising:
a clevis defining a third axis and being configured to rotatably coupled the upper control arm about the third axis;
a first aperture coaxial with the first axis when the upper control arm relocation bracket is mounted to the axle; and
a second aperture coaxial with the second axis when the upper control arm relocation bracket is mounted to the axle.

2. The upper control arm relocation bracket of claim 1, wherein the third axis is parallel to the first axis.

3. The upper control arm relocation bracket of claim 1, wherein a fastener that couples the lower control arm to the lower control arm bracket extends through the second aperture to couple the upper control arm relocation bracket to the lower control arm bracket.

4. The upper control arm relocation bracket of claim 3, further comprising a lug, wherein the second aperture extends through the lug.

5. The upper control arm relocation bracket of claim 4, wherein a first face of the lug engages the lower control arm bracket when the upper control arm relocation bracket is mounted to the axle.

6. The upper control arm relocation bracket of claim 5, wherein a counterbore extends partially through the lug from a second face.

7. The upper control arm relocation bracket of claim of claim 3, wherein a second fastener extends along the first axis to couple the bracket to the upper control arm bracket.

8. The upper control arm relocation bracket of claim 7, wherein the upper control arm bracket comprises an inner lug and an outer lug, the clevis engaging at least one of the inner lug and the outer lug.

9. The upper control arm relocation bracket of claim 8, wherein the inner lug is at least disposed between first and second legs of the clevis.

10. The upper control arm relocation bracket of claim 1, wherein the third axis is positioned above and forward of the second axis when the bracket is mounted to the axle.

11. The upper control arm relocation bracket of claim 1, wherein the third axis is positioned to lower an instant center of the upper and lower control arms.

12. The upper control arm relocation bracket of claim 11, wherein lowering the instant center reduces vehicle anti-squat from greater than 100% to less than 100%.

13. The upper control arm relocation bracket of claim 11, wherein the third axis is positioned to reduce pinion angle when the vehicle is in a full droop state.

14. A method of modifying a control arm geometry for a vehicle suspension, the vehicle suspension comprising an upper control coupled to an axle by an upper control arm bracket and a lower control arm coupled to the axle by a lower control arm bracket, the method comprising the steps of:
removing a first fastener to decouple the upper control arm from the upper control arm bracket;
removing a second fastener to decouple the lower control arm from the lower control arm bracket;
coupling an upper control arm relocation bracket to the upper control arm bracket using a third fastener;
coupling the upper control arm relocation bracket and the lower control arm to the lower controller arm using a fourth fastener; and
coupling the upper control arm to the upper control arm relocation bracket using a fifth fastener.

15. The method of claim 14, wherein the step of coupling the upper control arm relocation bracket to the upper control arm bracket using a third fastener includes inserting the third fastener into at least one hole of the upper control arm bracket from which the first fastener was removed.

16. The method of claim 14, wherein the step of coupling the upper control arm relocation bracket to the lower control arm bracket using a fourth fastener includes inserting the fourth fastener into at least one hole of the lower control arm bracket from which the second fastener was removed.

17. The method of claim 14, wherein the fifth fastener is the same as the second fastener.

18. The method of claim 14, further comprising the step of positioning the upper control arm relocation bracket next to the lower control arm bracket prior to coupling lower control arm.

19. The method of claim 14, wherein the upper control arm relocation bracket raises a rear end of the upper control arm.

20. The method of claim 14, wherein the upper control arm relocation bracket moves a rear end of the upper control arm in a forward direction.
